(19) United States
(12) Patent Application Publication
(10) Pub. No.: US 2008/0137618 A1
(43) Pub. Date: Jun. 12, 2008

(54) LOOK-AHEAD BANDWIDTH REQUESTING METHOD IN MOBILE COMMUNICATION SYSTEM AND MOBILE TERMINAL USING THE SAME

(75) Inventors: Nak-Woon SUNG, Daejeon (KR); Kyung-Soo KIM, Daejeon (KR)

Correspondence Address: Jefferson IP Law, LLP, 1730 M Street, NW, Suite 807, Washington, DC, 20036, US

(73) Assignees: Electronics and Telecommunications Research Institute, Daejeon (KR); Samsung Electronics Co., Ltd., Suwon-si (KR)

(21) Appl. No.: 11/876,759

(22) Filed: Oct. 22, 2007

(30) Foreign Application Priority Data
Dec. 6, 2006 (KR) 10-2006-0123011

(51) Int. Cl. H04J 3/00

(52) U.S. Cl. 370/336

(57) ABSTRACT

A look-ahead bandwidth requesting method and a mobile terminal using the look-ahead bandwidth requesting method in a mobile communication system are provided. The mobile terminal receives a downlink packet from a base station and transmits the downlink packet to a terminal equipment system. If the downlink packet received from the base station is a TCP packet, the mobile terminal transmits the TCP packet to the terminal equipment system and, at the same time, performs a bandwidth requesting procedure for being allocated a wireless resource through which a TCP ACK packet is to be transmitted to the base station. The bandwidth request is performed by using a random access procedure. The mobile terminal transmits the TCP ACK packet received from the terminal equipment system through the wireless resource that is allocated in advance by using the random access procedure to the base station. As a result, a random access delay is removed or minimized in a mobile terminal for uplink transmission in an asymmetric Internet traffic environment, so that an uplink transmission speed can be increased. Accordingly, a round-trip time of a TCP layer can be reduced, so that a high-speed service can be provided to an application program of a terminal equipment system.

### CROSS-REFERENCE TO RELATED APPLICATION

This application claims priority to and the benefit of Korean Patent Application No. 10-2006-0123011 filed in the Korean Intellectual Property Office on Dec. 06, 2006, the entire contents of which are incorporated herein by reference.

### BACKGROUND OF THE INVENTION

(a) Field of the Invention

The present invention relates to a bandwidth requesting method in a mobile communication system and, more particularly, to a look-ahead bandwidth requesting method of performing bandwidth request for acknowledge (hereinafter, referred to as an “ACK”) of reception of a transmission control protocol (TCP) packet received by a mobile terminal and a mobile terminal using the look-ahead bandwidth requesting method.

(b) Description of the Related Art

In general, in a mobile communication system based on a time division multiple access (TDMA) scheme such as a wireless broadband (WiBro) Internet system, a mobile terminal is designed to perform a wireless resource allocation requesting procedure for uplink transmission. In addition, general Web traffic has a characteristic of an asymmetric traffic amount so that an amount of a downlink traffic transmitted from a base station to a mobile terminal is larger than that of an uplink traffic transmitted from the mobile terminal to the base station.

The TCP is used as a basic protocol for various Internet application layers such as a hypertext transfer protocol (HTTP) layer and a real-time transfer protocol (RTP) layer in the Web service. As is well known, the TCP has a function of transferring user data in an end-to-end scheme without errors. Therefore, a reception side is designed to transmit an ACK for a received TCP segment, and a transmission side is designed to perform congestion control if the ACK is not received.

In addition, conventionally, a delayed ACK scheme may be used for the TCP layer. Namely, at the time that the reception side transmits the ACK for the received TCP segment, if there is data that the reception side is to transmit, the reception side transmits the ACK and the data on one packet. This is a kind of piggyback ACK scheme. In the scheme, the reception side does not immediately transmit the ACK, but rather it delays the transmission of the ACK for a predetermined time interval, typically for 200 ms. If to-be-transmitted data occurs in the time interval, the reception side transmits the ACK together with the data. If not, the reception side transmits only the ACK after the predetermined time interval elapses.

In addition, conventionally, when the mobile terminal transmits uplink data to the base station, a wireless resource allocation requesting procedure, that is, a random access procedure, is designed to be performed. During the random access procedure, a random access delay occurs in order to perform actual uplink data transmission. The random access delay may correspond to several frames or tens of frames. In addition, the random access delay is affected by a period of frame. In the WiBro system, 2 ms, 2.5 ms, 4 ms, 5 ms, 8 ms, and 10 ms are defined as the periods of a frame, so that the random access delay may be tens of milli-seconds or hundreds of milli-seconds. Therefore, when the mobile terminal receives the uplink packet from a terminal equipment system and performs the random access procedure to transmit the uplink packet to the base station, the random access delay is added to all the uplink data transmissions, so that there is a problem in that system performance is seriously affected.

In order to solve the problem, there is proposed a technique for predicting a traffic model in advance, and predicting an arrival of the uplink packet based on the traffic model to perform the random access procedure. However, in the technique, only the prediction is performed. Therefore, probabilities of failure of prediction of an accurate traffic model and failure of prediction of a current propagation environment are increased. In addition, due to the failure of prediction, an uplink wireless resource, which is more expensive than the downlink resource, is wastefully used. As a result, the entire performance of the system is deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a look-ahead bandwidth requesting method and a mobile terminal using the look-ahead bandwidth requesting method in a mobile communication system having advantages of being capable of minimizing a random access delay at the time of transmitting an ACK to a received TCP packet.

An exemplary embodiment of the present invention provides a mobile terminal for providing a communication service to a terminal equipment system through a mobile communication network, including: a convergence sublayer unit that transmits to the terminal equipment system a downlink packet and, at the same time, notifies arrival of the downlink packet, if the downlink packet transmitted from a base station to the terminal equipment system is a packet requiring acknowledgement (ACK); and a scheduler that is allocated from the base station with a wireless resource through which an ACK packet for the downlink packet is to be transmitted if the arrival of the downlink packet requiring the ACK is notified by the convergence sublayer unit.

Another embodiment of the present invention provides a look-ahead bandwidth requesting method in a mobile terminal for providing a communication service to a terminal equipment system through a mobile communication network, including: when a downlink packet that is to be transmitted from a base station to the terminal equipment system is received, determining whether or not the downlink packet is a packet requiring acknowledgement (ACK); if the downlink packet is a packet requiring ACK, transmitting the downlink packet to the terminal equipment system and, at the same time, requesting the base station to allocate a wireless resource through which an ACK packet for the downlink packet is to be transmitted; and being allocated, from the base station, the wireless resource through which the ACK packet for the downlink packet is to be transmitted.

Yet another embodiment of the present invention provides a look-ahead bandwidth requesting method in a mobile terminal for providing a communication service to a terminal equipment system through a mobile communication network, including: when a downlink packet that is to be transmitted from a base station to the terminal equipment system is received, determining whether or not the downlink packet is a packet requiring acknowledgement (ACK); if the downlink packet is a packet requiring ACK, transmitting the downlink packet to the terminal equipment system; generating a random access delay of a random access procedure so as to be allocated a wireless resource through which the ACK packet is to be transmitted before the ACK packet for the downlink packet is received from the terminal equipment system; and if the ACK packet is transmitted from the terminal equipment system, transmitting the ACK packet to the base station through the wireless resource allocated during the random access procedure.

### BRIEF DESCRIPTION OF THE DRAWINGS

FIG. 1 is a flowchart illustrating a general bandwidth requesting method in a mobile communication system.

FIG. 2 is a schematic diagram illustrating a mobile communication system in which a mobile terminal according to an exemplary embodiment of the present invention is employed.

FIG. 3 is a flowchart illustrating a look-ahead bandwidth requesting method in a mobile communication system according to an exemplary embodiment of the present invention.

FIG. 4 is a flowchart illustrating a random access procedure of performing look-ahead bandwidth request in a mobile communication system according to an exemplary embodiment of the present invention.

### DETAILED DESCRIPTION OF THE EMBODIMENTS

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention. In addition, for clarifying the present invention, portions that are not directly related to the description are omitted in the drawings. Like reference numerals denotes like elements throughout the specification.

In the specification, it should be noted that a phrase that a portion “includes” an element means that another element is not excluded but can be further included therein if a particularly contrary phase is not disclosed.

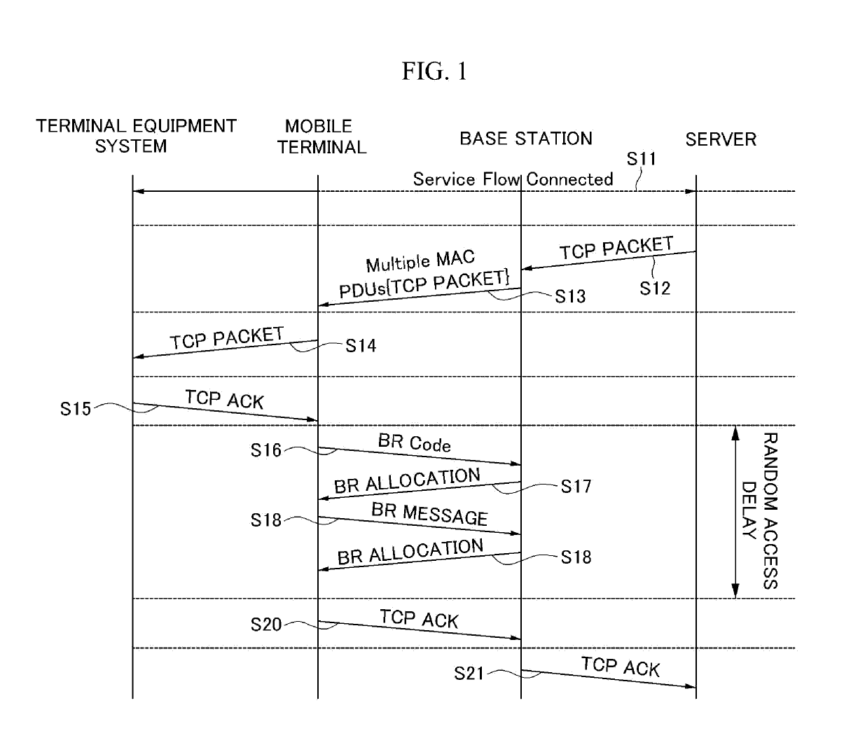

Firstly, a general bandwidth requesting method in a mobile communication system is described with reference to FIG. 1.

FIG. 1 is a flowchart of transmission of TCP packets in a general WiBro system including a terminal and a base station. In this case, the Web service, that is, a representative Internet application program, may be used, and the HTTP protocols may also use the TCP function. As is well known, most Web services are provided in an asymmetric traffic structure in which an Internet server provides a long-length content with respect to a short-length user request.

First, when the mobile terminal is notified of a start of application program service from the terminal equipment system, the mobile terminal sets up service flow connection to the base station (S11). As a result, a user can visit an arbitrary Internet site according to their necessities or preferences.

Next, in response to a user's request, an Internet server transmits requested content to the base station by using HTTP/TCP/IP protocol packets (S12). The base station fragments the TCP packet into a plurality of medium access control (MAC) protocol data units (PDUs), and transmits the MAC PDUs to the mobile terminal (S13).

Subsequently, the mobile terminal that receives the MAC PDUs from the base station reassembles the MAC PDUs to generate the TCP packet, that is, a service data unit (SDU), and transfers the SDU to the terminal equipment system (S14).

The terminal equipment system transfers the TCP ACK for the received TCP packet to the mobile station according to the TCP protocol (S15).

In order to perform the random access procedure for transmitting to the base station the TCP ACK that is transferred from the terminal equipment system, the mobile terminal transmits a wireless resource allocation request code, that is, a bandwidth request (BR) code, to the base station (S16). In general, in the random access procedure, a random code is transmitted at random in a wireless resource allocation section, and if there is conflict between the base station and another terminal, re-transmission thereof is performed. In this case, in order to reduce a probability of conflict, a re-transmission algorithm (back-off procedure algorithm) is performed to transmit the code in a time period that is a multiple of a re-transmission period.

Next, in response to the received wireless resource allocation request code, the base station allocates an uplink resource that is used for transmitting a wireless resource allocation request message (BR message) to the mobile station (S17).

Next, the mobile terminal generates the wireless resource allocation request message (BR message) and transmits the wireless resource allocation request message to the base station through the allocated uplink resource (S18). The BR message has a size of the wireless resource for transmitting an uplink data, that is, the ACK packet in this case. The base station that receives the wireless resource allocation request message allocates the requested size of uplink wireless resource (BR allocation) to the mobile station (S19). Here, a time interval, from the procedure S16 in which the mobile terminal transmits the BR code to the base station to when the BR allocation procedure S19 in which the mobile terminal is allocated the uplink wireless resource by the base station occurs, corresponds to the random access delay. In a general bandwidth requesting procedure, such a random access delay occurs.

Next, the mobile terminal transmits the ACK transferred from the terminal equipment system to the base station through the uplink resource allocated in the procedure S19 (S20). The base station transmits the ACK to the server, so that the Web service can proceed (S21).

As described above, in such an asymmetric Web service using the TCP protocol, particularly a high-speed multimedia service, the random access procedure starts to be performed after the TCP ACK packet is transmitted from the terminal equipment system to the mobile terminal, so that the random access delay occurs in the uplink packet transmission.

Hereinafter, a look-ahead bandwidth requesting apparatus in a mobile communication system according to an exemplary embodiment of the present invention is described with reference to the drawings.

In the exemplary embodiment of the present invention, every time the mobile terminal receives the downlink TPC packet that is to be transmitted to the terminal equipment system, the mobile terminal predicts that the TCP ACK packet is to be transmitted as an uplink data from the terminal equipment system and transmits the TCP packet to the terminal equipment system. In addition, the mobile terminal performs the random access procedure in advance of being allocated the uplink wireless resource. As a result, when the TCP ACK packet arrives from the terminal equipment system, the mobile terminal can transmit the TCP ACK packet to the base station without a random access delay through the allocated uplink wireless resource.

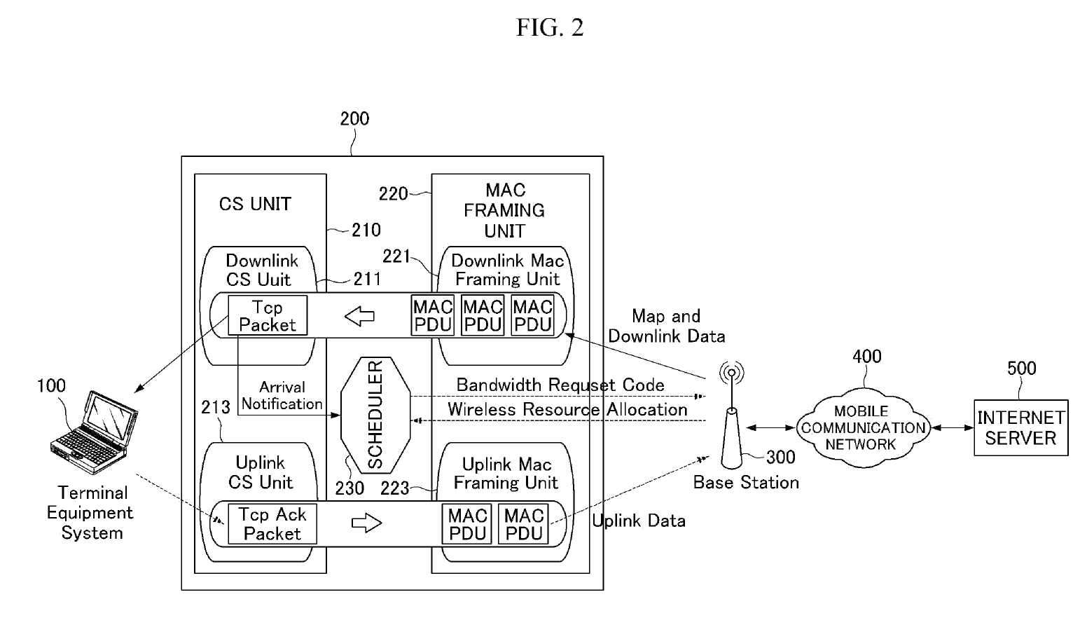

FIG. 2 is a schematic diagram illustrating a mobile communication system in which a mobile terminal according to an exemplary embodiment of the present invention is employed.

As shown in FIG. 2, the mobile communication system according to the exemplary embodiment of the present invention includes a terminal equipment system (TES) 100, a mobile terminal (access terminal (AT)) 200, and a base station (access point (AP)) 300.

The terminal equipment system 100 is an apparatus such as a laptop having a TCP/IP layer to perform an Internet application program.

The mobile terminal 200 is connected to the terminal equipment system 100 through a universal serial bus (USB), a PCMCIA (Personal Computer Memory Card International Association) interface, or the like. The mobile terminal 200 is connected to the base station 300 through a wireless environment, so that the terminal equipment system 100 can use the Internet service in the mobile communication system.

The base station 300 provides a mobile communication service to the mobile terminal 200 in the mobile communication system. The base station 300 is connected to the Internet, so that the Internet service can be provided to the terminal equipment system 100 through the mobile terminal 200. In addition, the base station 300 is connected to an Internet server 500 through a mobile communication network 400, so that the Internet service can be provided to the terminal equipment system 100.

In a case where the mobile terminal according to the exemplary embodiment of the present invention receives a TCP packet that is to be transferred from the base station 300 to the terminal equipment system 100, while the mobile terminal 200 transfers the TCP packet to the terminal equipment system 100, the mobile terminal 200 performs a random access procedure for allowing the base station to allocate the uplink wireless resource in advance through which the mobile terminal 200 is to transmit a TCP ACK packet for the TCP packet.

The mobile terminal 200 includes a convergence sublayer (CS) unit 210, a MAC framing unit 220, and a scheduler 230.

The CS unit 210 receives an uplink packet from the terminal equipment system 100 and transmits the uplink packet to the MAC framing unit 220. The CS unit 210 receives a packet output from the MAC framing unit 220 and transmits the packet to the terminal equipment system 100. In a case where the packet transmitted from the MAC framing unit 220 is a TCP packet, the CS unit 210 transmits the TCP packet to the terminal equipment system 100 and, at the same time, notifies the scheduler 230 of the transmission of the TCP packet.

The CS unit 210 includes a downlink CS unit 211 and an uplink CS unit 213.

The downlink CS unit 211 receives the downlink packet transmitted from the base station 300 through the MAC framing unit 220, and transmits the downlink packet to the terminal equipment system 100. In a case where the packet transmitted from the base station 300 through the MAC framing unit 220 is the TCP packet, the downlink CS unit 211 transmits the TCP packet to the terminal equipment system 100 and, at the same time, notifies the scheduler 230 of the arrival of the TCP packet so that the scheduler 230 can predict that the TCP ACK packet is to arrive from the terminal equipment system 100.

The uplink CS unit 213 receives the uplink packet transmitted from the terminal equipment system 100 and transmits the uplink packet to the MAC framing unit 220. At this time, the uplink CS unit 213 determines an amount of wireless resource required to transmit the uplink packet that is transmitted from the terminal equipment system 100 to the base station 300. In addition, the uplink CS unit 213 classifies incoming packets from the terminal equipment system 100 to determine whether or not there is a service flow requiring a new QoS (Quality of Service). If a new connection between MAC layers of the mobile terminal 200 and the base station 300 is needed, the uplink CS unit 213 requests the scheduler 230 to set up the new connection. When the new connection is set up, the uplink CS unit 213 classifies the incoming packets from the terminal equipment system 100 and outputs the classified packets to the MAC framing unit 220.

The MAC framing unit 220 transmits the downlink packet transmitted from the base station 300 to the CS unit 210. The MAC framing unit 220 receives the uplink packet transmitted from the terminal equipment system 100 through the CS unit 210 and transmits the uplink packet to the base station 300.

The MAC framing unit 220 includes a downlink MAC framing unit 221 and an uplink MAC framing unit 223.

The downlink MAC framing unit 221 reassembles MAC PAUs transmitted from the base station 300 through a downlink channel to generate an SDU. The downlink MAC framing unit 221 transmits the SDU to the CS unit 210, particularly to the downlink CS unit 211.

The uplink MAC framing unit 223 fragments the SDU, that is, the packet transmitted from the CS unit 210, particularly from the uplink CS unit 213, according to commands of the scheduler 230, to generate MAC PDUs. The uplink MAC framing unit 223 transmits the MAC PAU to the base station 300 through an uplink channel.

In response to a request of the CS unit 210, particularly from the uplink CS unit 213, the scheduler 230 sets up connection to the base station 300 and performs the random access to the base station 300 for the service flow that is to be transmitted to the base station 300 to request the wireless resource allocation. The scheduler 230 requests the MAC framing unit 220, particularly the uplink MAC framing unit 223, to transmit the uplink packet of the service flow to the base station through the allocated wireless resource. Next, the scheduler 230 may command the physical layer to transmit a code for requesting the wireless resource allocation.

In addition, when the CS unit 210, particularly the downlink CS unit 211, notifies of the arrival of the TCP packet, the scheduler 230 can predict that the TCP ACK packet from the terminal equipment system 100 is to arrive after the passage of a predetermined time interval and to be transmitted to the base station 300. Therefore, the scheduler 230 is allocated the wireless recourse used for transmitting the TCP ACK packet to the base station 300. More specifically, the scheduler 230 is allocated the wireless resource by performing different procedures according to whether or not the random access procedure currently proceeds, whether or not an uplink packet transmission proceeds, and the like. For example, if there is no currently proceeding procedure, the scheduler 230 performs the random access procedure to be allocated the wireless resource. If there is a proceeding random access procedure, the scheduler 230 requests an additional wireless resource used for transmitting the TCP ACK packet to the base station 300 so it can be allocated the wireless resource. If the uplink packet transmission through the uplink proceeds, the scheduler 230 is allocated the wireless resource used for transmitting the TCP ACK packet in a piggyback scheme by using a MAC sub-header. The scheme is well known, and thus detailed description thereof is omitted.

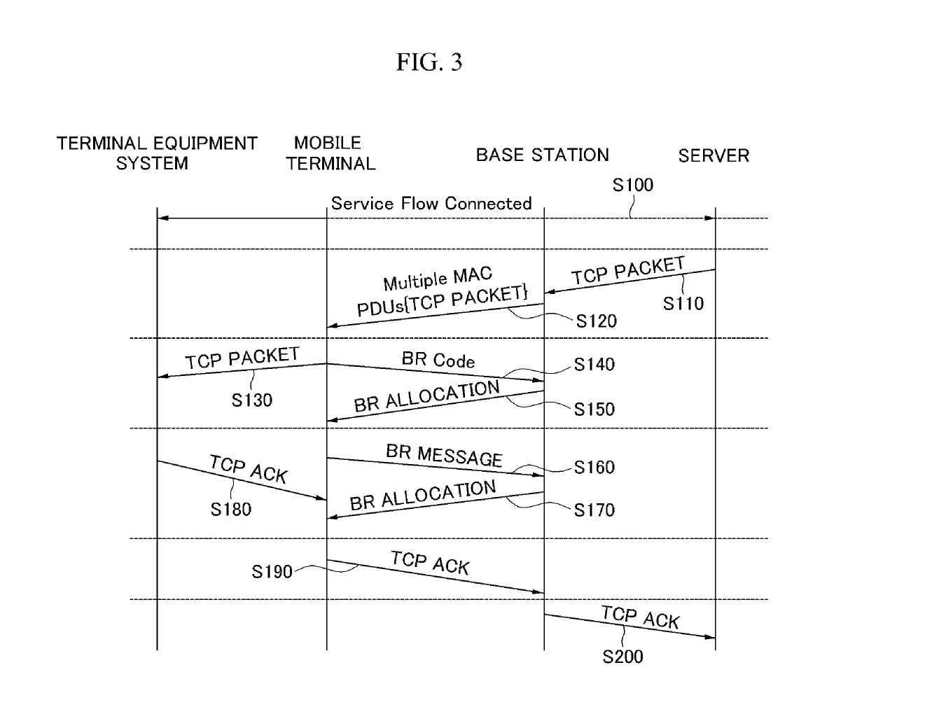

Now, a look-ahead bandwidth requesting method in a mobile communication system according to an exemplary embodiment of the present invention is described in detail with reference to FIG. 3.

The look-ahead bandwidth requesting method according to the exemplary embodiment of the present invention is described as a representative Internet application program, that is, the Web service is exemplified. However, the present invention is not limited thereto, but the present invention can be employed in all kinds of service flows in which the terminal equipment system 100 receives the TCP packet through the mobile terminal 200 and transmits the TCP ACK packet for the received TCP packet to the base station through the mobile terminal 200. As is well known, most of the Web services are provided in an asymmetric traffic structure in which the Internet server 500 provides long-length content with respect to a short-length user request.

When the scheduler 230 of the mobile terminal 200 is notified of a start of application program service from the terminal equipment system, the mobile terminal sets up a service flow connection to the base station (S100). As a result, a user can visit an arbitrary Internet site through the Internet server 500 according to their necessities or preferences. During the Internet service, in response to a user's request, the Internet server 500 transmits requested content to the base station by using HTTP/TCP/IP protocol packets (S110).

The base station 300 fragments the TCP packet transmitted from the Internet server 500 into a plurality of MAC PDUs, and transmits the MAC PDUs to the mobile terminal 200 (S120).

Subsequently, the mobile terminal 200 reassembles the MAC PDUs transmitted from the base station 300 to generate the TCP packet, that is, the SDU, and transfers the SDU to the terminal equipment system 100 (S130). Simultaneously, the mobile terminal 200 performs the random access procedures S140, S150, S160, and S170 to the base station 300 to be allocated the wireless resource. An amount of the allocated wireless resource corresponds to an amount of data required to transmit the TCP ACK packet (S180) received from the terminal equipment system 100 to the base station 300 with respect to the TCP packet transmitted to the terminal equipment system 100.

Next, the mobile terminal 200 transmits the TCP ACK packet transmitted in the procedure S180 to the base station 300 by using the wireless resource allocated in the random access procedures S140, S150, S160, and S170.

In this manner, the mobile terminal 200 receives, from the base station 300, the TCP packet that is to be transmitted from the terminal equipment system 100, and transmits the TCP packet to the terminal equipment system 100, and at the same time the mobile terminal 200 performs the random access procedures to be allocated the wireless resource through which the TCP ACK packet is to be transmitted, so that the random access delay almost does not occur, unlike in a conventional mobile communication system.

Now, the random access procedure will be described in more detail. For convenience of description, in FIG. 3, like reference numerals denote like procedures.

In the procedure S120, when the mobile terminal 200 receives the TCP ACK packet from the base station 300, the downlink MAC framing unit 221 reassembles the received MAC PDUs to generate the TCP packet, that is, the SDU, and transmits the SDU to the downlink CS unit 211 (S121).

The downlink CS unit 211 determines whether or not the SDU transmitted from the downlink MAC framing unit 221 is a TCP packet (S122). If the SDU is determined to not be the TCP packet, the TCP ACK packet is to be received. In this case, since the look-ahead bandwidth requesting procedure according to the exemplary embodiment of the present invention is unnecessary, the downlink CS unit 211 transmits the SDU to the terminal equipment system 100, and all the procedures are ended. If the SDU is determined to be the TCP packet in the procedure S122, the downlink CS unit 211 transmits the TCP packet to the terminal equipment system 100 (S130), and transmits an arrival notification message notifying that the TCP packet arrives from the base station 300, to the scheduler 230.

The scheduler 230 predicts that the TCP ACK packet is to arrive from the terminal equipment system 100 after the passage of a predetermined time interval by using the arrival notification message transmitted from the downlink CS unit 211. Therefore, the scheduler 230 needs to be allocated the wireless resource through which the predicted TCP ACK packet is to be transmitted to the base station 300. For the allocation of the wireless resource, the scheduler 230 determines whether or not the random access procedure currently proceeds and whether or not an uplink packet transmission proceeds. For the convenience of description, in the exemplary embodiment, it is determined whether or not the random access procedure currently proceeds. More specifically, the scheduler 230 determines whether or not the random access procedure currently proceeds (S131). If there is no currently proceeding random access procedure, the scheduler 230 performs the random access procedure to be allocated the wireless resource. Namely, the scheduler 230 transmits a wireless resource allocation request code (BR Code) to the base station 300 (S140). As a result, the scheduler 230 is allocated the uplink resource from the base station 300, through which the wireless resource allocation request message (BR Message) is to be transmitted (BR allocation) (S150). Next, the mobile terminal 300 generates the wireless resource allocation request message (BR message) indicating an amount of the wireless resource used to transmit the TCP ACK packet, and transmits the wireless resource allocation request message (BR message) to the base station 300 through the uplink resource allocated in the procedure S150 (S160). As a result, the mobile terminal 300 is allocated the wireless resource from the base station 300 (S170).

Since the scheduler 230 is allocated the wireless resource through which the TCP ACK packet is to be transmitted in advance, the uplink CS unit 213 of the mobile terminal 200 stands by until the TCP ACK packet is transmitted from the terminal equipment system 100 (S171). Next, the uplink CS unit 213 may receive the TCP ACK packet from the terminal equipment system 100 (S180). Otherwise, during the random access procedures S140, S150, S160, and S170, the uplink CS unit 213 may receive the TCP ACK packet from the terminal equipment system 100 (S180). In these cases, the uplink CS unit 213 transmits the SDU to the uplink MAC framing unit 223, that is, the TCP ACK packet transmitted from the terminal equipment system 100. The uplink MAC framing unit 223 that receives the SDU from the uplink CS unit 213 fragments the SDU according to commands of the scheduler 230 to generate the MAC PDUs, and transmits the MAC PDUs to the base station 300 (S180). Next, the base station 300 reassembles the MAC PDUs transmitted from the mobile terminal 200 to generate the SDU, that is, the TCP ACK packet, and transmits the SDU to the Internet server 500 through the mobile communication network 400, so that the Web service can proceed.

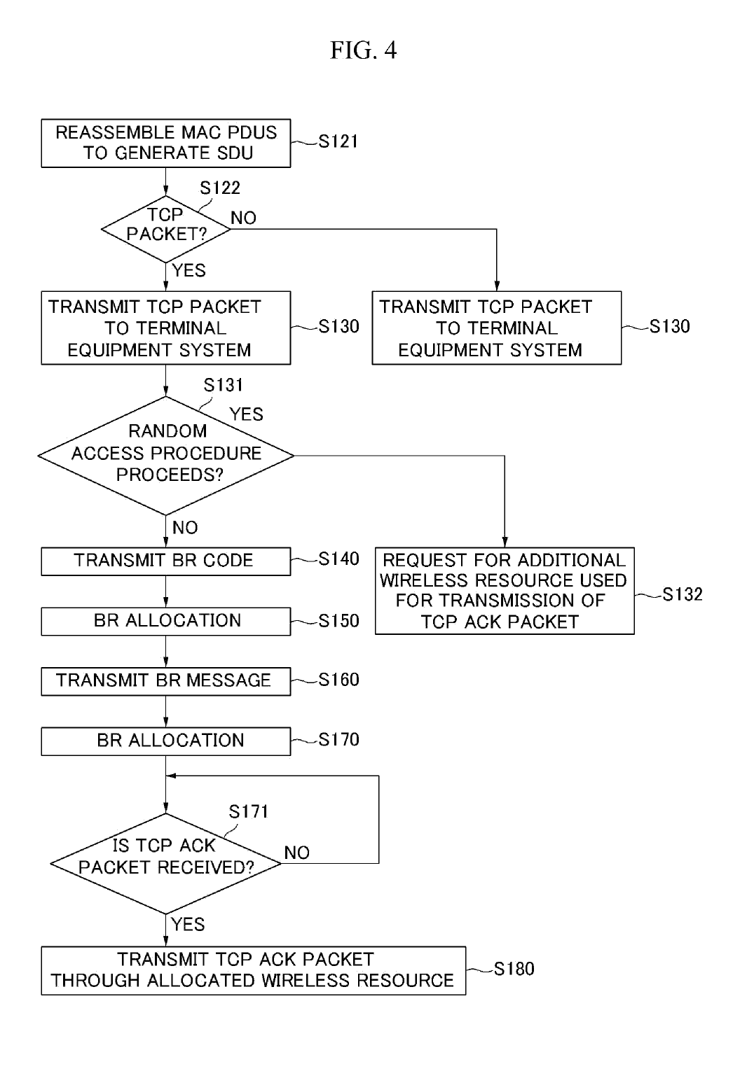

As described above with reference to FIGS. 3 and 4, the random access delay from the procedure S140 in which the scheduler 230 of the mobile terminal 200 transmits the BR code to the base station 300, to the BR allocation procedure S170 in which the scheduler 230 is allocated the uplink wireless resource through which the TCP ACK packet is to be transmitted, from the base station, is ended in a time interval from the procedure S130 in which the TCP packet is transmitted to the terminal equipment system 100 to the procedure S180 in which the TCP ACK packet is received from the terminal equipment system 100. Otherwise, the random access delay is ended in a short time after the procedure S180 in which the TCP ACK packet is received from the terminal equipment system 100. Therefore, after the TCP ACK packet is received, the TCP ACK packet can be speedily transmitted to the base station 300.

In addition, if the random access procedure is determined to currently proceed in the procedure S131, the scheduler 230 requests an additional wireless resource to be used for transmitting the TCP ACK packet at the time of transmitting the wireless resource allocation request message (BR message), so that the scheduler 230 can be allocated the additional wireless resource.

In addition, in a case where a normal random access procedure is difficult to perform due to a proceeding uplink data transmission, the scheduler 230 requests the wireless resource allocation for the transmission of the TCP ACK packet in a piggyback ACK scheme using a MAC sub-header, so that the scheduler 230 can be allocated the wireless resource.

Although exemplary embodiments and modified examples of the present invention have been described, the present invention is not limited to the embodiments and examples, but may be modified in various for ms without departing from the scope of the appended claims, the detailed description, and the accompanying drawings of the present invention. Therefore, it is natural that such modifications belong to the scope of the present invention.

According to the present invention, a random access delay is removed or minimized in a mobile terminal for uplink transmission in an asymmetric Internet traffic environment, so that an uplink transmission speed can be increased.

As a result, a round-trip time of a TCP layer can be reduced, so that a high-speed service can be provided to an application program of a terminal equipment system.

Accordingly, the uplink resource can be efficiently used in a wireless communication system, so that the entire performance of the wireless communication system can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mobile terminal for providing a communication service to a terminal equipment system through a mobile communication network, comprising:
a convergence sublayer unit that transmits a downlink packet to the terminal equipment system and, at the same time, notifies of arrival of the downlink packet, if the downlink packet transmitted from a base station to the terminal equipment system is a packet requiring acknowledgement (ACK); and
a scheduler that is allocated from the base station with a wireless resource through which an ACK packet for the downlink packet is to be transmitted if the arrival of the downlink packet requiring the ACK is notified by the convergence sublayer unit.

2. The mobile terminal of claim 1, wherein, if the arrival of the downlink packet requiring the ACK is notified by the convergence sublayer unit, the scheduler performs a random access procedure to the base station to be allocated the wireless resource through which the ACK packet for the downlink packet is to be transmitted.

3. The mobile terminal of claim 1,
wherein the convergence sublayer unit comprises:
a downlink convergence sublayer unit that receives the downlink packet and transmits the downlink packet to the terminal equipment system; and
an uplink convergence sublayer unit that transmits an uplink packet transmitted from the terminal equipment system to the base station,
wherein, if the ACK received from the base station is required in the downlink packet, the downlink convergence sublayer unit transmits the downlink packet to the terminal equipment system and, at the same time, transmits an arrival notification message notifying that the downlink packet arrives to the scheduler.

4. The mobile terminal of claim 1, wherein, if the ACK packet for the downlink packet is transmitted from the terminal equipment system, the convergence sublayer unit transmits the ACK packet to the base station through the wireless resource that is allocated to the scheduler.

5. The mobile terminal of claim 2, wherein, if the scheduler performs the random access procedure at the time that the arrival of the downlink packet requiring the ACK is notified by the convergence sublayer unit, the scheduler is allocated an additional wireless resource through which the ACK packet for the downlink packet is to be transmitted.

6. The mobile terminal of claim 2, wherein if the scheduler transmits the uplink packet to the base station at the time that the arrival of the downlink packet requiring the ACK is notified by the convergence sublayer unit, the scheduler is allocated a wireless resource through which the ACK packet for the downlink packet is to be transmitted in a piggyback ACK scheme using a MAC sub-header.

7. The mobile terminal of any one of claim 1, wherein the downlink packet requiring the ACK is a transmission control protocol (TCP) packet, and the ACK packet is a TCP ACK packet.

8. A look-ahead bandwidth requesting method in a mobile terminal for providing a communication service to a terminal equipment system through a mobile communication network, comprising:
when a downlink packet that is to be transmitted from a base station to the terminal equipment system is received, determining whether or not the downlink packet is a packet requiring acknowledgement (ACK);
if the downlink packet is a packet requiring ACK, transmitting the downlink packet to the terminal equipment system and, at the same time, requesting the base station to allocate a wireless resource through which an ACK packet for the downlink packet is to be transmitted; and
being allocated the wireless resource through which the ACK packet for the downlink packet is to be transmitted from the base station.

9. The look-ahead bandwidth requesting method of claim 8, further comprising, after the allocating of the wireless resource from the base station, transmitting the ACK packet for the downlink packet to the base station through the allocated wireless resource.

10. The look-ahead bandwidth requesting method of claim 8, wherein the wireless resource through which the ACK packet for the downlink packet is to be transmitted is allocated by performing a random access procedure to the base station.

11. The look-ahead bandwidth requesting method of claim 10, wherein the requesting that the base station allocate a wireless resource comprises:
transmitting a wireless resource allocation request code (bandwidth request (BR) Code) to the base station;
being allocated an uplink resource through which the wireless resource allocation request message (BR code) is to be transmitted from the base station; and
transmitting the wireless resource allocation request message (BR message) indicating a wireless resource through which the ACK packet is to be transmitted through the uplink resource through which the wireless resource allocation request message (BR code) is to be transmitted to the base station.

12. The look-ahead bandwidth requesting method of claim 8, wherein the wireless resource through which the ACK packet for the downlink packet is to be transmitted is additionally allocated during a random access procedure performed by the mobile terminal.

13. The look-ahead bandwidth requesting method of claim 8, wherein the wireless resource through which the ACK packet for the downlink packet is to be transmitted is allocated in a piggyback ACK scheme using a MAC sub-header.

14. A look-ahead bandwidth requesting method in a mobile terminal for providing a communication service to a terminal equipment system through a mobile communication network, comprising:
when a downlink packet that is to be transmitted from a base station to the terminal equipment system is received, determining whether or not the downlink packet is a packet requiring acknowledgement (ACK);
if the downlink packet is a packet requiring ACK, transmitting the downlink packet to the terminal equipment system;
generating a random access delay of a random access procedure so as to be allocated a wireless resource through which the ACK packet is to be transmitted before the ACK packet for the downlink packet is received from the terminal equipment system; and
if the ACK packet is transmitted from the terminal equipment system, transmitting the ACK packet to the base station through the wireless resource allocated during the random access procedure.

15. The look-ahead bandwidth requesting method of claim 14, wherein the generating the random access delay of the random access procedure comprises:
transmitting a wireless resource allocation request code (bandwidth request (BR) Code) to the base station;
being allocated an uplink resource through which the wireless resource allocation request message (BR code) is to be transmitted from the base station;
transmitting the wireless resource allocation request message (BR message) indicating a wireless resource through which the ACK packet is to be transmitted through the uplink resource through which the wireless resource allocation request message (BR code) is to be transmitted, to the base station; and
being allocated the wireless resource through which the ACK packet for the downlink packet is to be transmitted.
